(19) United States
(12) Patent Application Publication
(10) Pub. No.: US 2025/0138900 A1
(43) Pub. Date: May 1, 2025

(54) OFFLOADING EXECUTION OF SERVER-SIDE CODE TO CLIENT DEVICES IN AN INFORMATION TECHNOLOGY INFRASTRUCTURE ENVIRONMENT

(71) Applicant: Dell Products L.P., Round Rock, TX (US)

(72) Inventors: Rajiv Popat, Kolkata (IN); Bijan Kumar Mohanty, Austin, TX (US); Hung Dinh, Austin, TX (US)

(21) Appl. No.: 18/493,976

(22) Filed: Oct. 25, 2023

(51) Int. Cl. G06F 9/50

(52) U.S. Cl. CPC G06F 9/5072; G06F 9/5038; G06F 9/5044; G06F 9/5055; G06F 2209/503; G06F 2209/509

(57) ABSTRACT

An apparatus comprises at least one processing device configured to maintain an execution queue data structure comprising tasks to be executed, the tasks comprising execution of server-side code for application services hosted by servers in an information technology infrastructure environment. The at least one processing device is also configured to determine hardware and software requirements for the tasks in the execution queue data structure, and to determine hardware and software resources available on client devices in the information technology infrastructure environment. The at least one processing device is further configured to offload execution of at least a subset of the tasks in the execution queue data structure from the servers to the client devices based at least in part on mapping the determined available hardware and software resources of the client devices with the determined hardware and software requirements for the tasks in the execution queue data structure.

### BACKGROUND

Web applications, also referred to as web apps, are application programs designed for delivery to users over a network, such as the Internet, through a browser interface. For example, web applications include client-server computer programs in which the client runs in a web browser and the web application is hosted in the server. Web applications may include web services and other website components that perform functions for users. Various software frameworks may be used to provide web applications. Such software frameworks, also referred to as web frameworks or web application frameworks, facilitate the building and deployment of web applications. For example, web application frameworks can provide common libraries for various application functions and promote code re-use.

### SUMMARY

Illustrative embodiments of the present disclosure provide techniques for offloading execution of server-side code to client devices in an information technology infrastructure environment.

In one embodiment, an apparatus comprises at least one processing device comprising a processor coupled to a memory. The at least one processing device is configured to maintain an execution queue data structure, the execution queue data structure comprising a plurality of tasks to be executed, each of the plurality of tasks comprising execution of server-side code for one or more application services hosted by one or more servers in an information technology infrastructure environment. The at least one processing device is also configured to determine at least one of hardware and software requirements for the plurality of tasks in the execution queue data structure, and to determine at least one of hardware and software resources available on a set of client devices in the information technology infrastructure environment. The at least one processing device is further configured to offload execution of at least a subset of the plurality of tasks in the execution queue data structure from the one or more servers in the information technology infrastructure environment to at least one of the set of client devices in the information technology infrastructure environment based at least in part on mapping the determined available hardware and software resources of the set of client devices in the information technology infrastructure environment with the determined hardware and software requirements for the plurality of tasks in the execution queue data structure.

These and other illustrative embodiments include, without limitation, methods, apparatus, networks, systems and processor-readable storage media.

### BRIEF DESCRIPTION OF THE DRAWINGS

FIG. 1 is a block diagram of an information processing system configured for offloading execution of server-side code to client devices in an information technology infrastructure environment in an illustrative embodiment.

FIG. 2 is a flow diagram of an exemplary process for offloading execution of server-side code to client devices in an information technology infrastructure environment in an illustrative embodiment.

FIG. 3 shows a system configured for offloading of server-side code execution to a set of volunteer client devices in an illustrative embodiment.

FIGS. 4 and 5 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources.

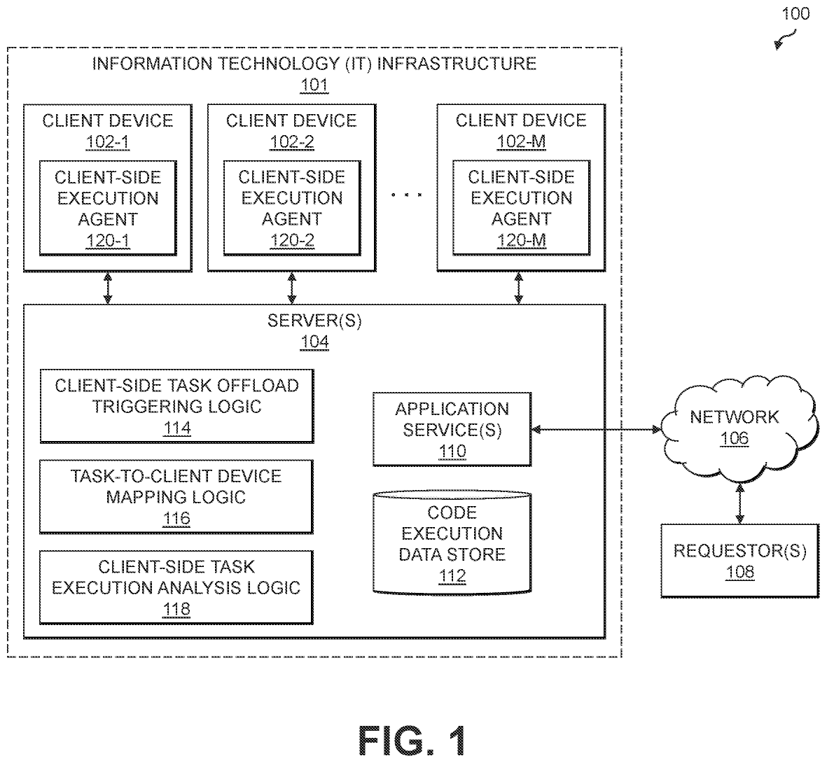

FIG. 1 shows an information processing system 100 configured in accordance with an illustrative embodiment. The information processing system 100 is assumed to be built on at least one processing platform and provides functionality for offloading execution of server-side code to client devices in an information technology (IT) infrastructure environment. The information processing system 100 includes an IT infrastructure 101 comprising a set of client devices 102-1, 102-2, . . . 102-M (collectively, client devices 102) implementing client-side execution agents 120-1, 120-2, . . . 120-M (collectively, client-side execution agents 120), and one or more servers 104. The client devices 102 and servers 104 are assumed to be connected to one another within the IT infrastructure 101 via one or more networks (not shown). The servers 104 are also coupled, via network 106, to a set of one or more requestors 108. The requestors 108 are assumed to request access to one or more application services 110 offered by the servers 104. Such requests, for example, may be to run one or more jobs or tasks (e.g., execute code) server-side. The IT infrastructure 101 may comprise physical and/or virtual computing resources. Physical computing resources may include physical hardware such as the servers 104, storage systems (e.g., implementing code execution data store 112), networking equipment, Internet of Things (IoT) devices, other types of processing and computing devices (e.g., client devices 102) including desktops, laptops, tablets, smartphones, etc. Virtual computing resources may include virtual machines (VMs), containers, etc., which may run on the physical computing resources.

In some embodiments, the IT infrastructure 101 is used for or by an enterprise system or other organization. The enterprise system may utilize the servers 104 to offer the application services 110 (e.g., which are consumed by the requestors 108). The application services 110 may comprise, for example, one or more web applications hosted by the servers 104. Each of the client devices 102 (as well as other client devices outside the IT infrastructure 101, such as the requestors 108) may run a web browser utilized to access the web applications hosted by the servers 104 as the application services 110. Web applications may be implemented as application programs designed for delivery to users over a network (e.g., network 106) through a browser interface. Web applications and other types of application services 110 may be implemented using a client-server architecture, in which the client runs in a web browser (e.g., on the client devices 102 or requestors 108) while the application is hosted in the servers 104. The application services 110 may in some embodiments be provided as cloud services that are accessible by one or more of the client devices 102 and/or requestors 108.

As used herein, the term “enterprise system” is intended to be construed broadly to include any group of systems or other computing devices. For example, IT assets of the IT infrastructure 101 (e.g., the client devices 102 and servers 104) may provide a portion of one or more enterprise systems. In some embodiments, an enterprise system includes one or more data centers, cloud infrastructure comprising one or more clouds, etc. A given enterprise system, such as cloud infrastructure, may host assets that are associated with multiple enterprises (e.g., two or more different businesses, organizations or other entities).

The client devices 102 may comprise, for example, physical computing devices such as IoT devices, mobile telephones, laptop computers, tablet computers, desktop computers or other types of devices utilized by members of an enterprise, in any combination. Such devices are examples of what are more generally referred to herein as “processing devices.” Some of these processing devices are also generally referred to herein as “computers.” The client devices 102 may also or alternately comprise virtualized computing resources, such as VMs, containers, etc.

The client devices 102 in some embodiments comprise respective computers associated with a particular company, organization or other enterprise. Thus, the client devices 102 may be considered examples of assets of an enterprise system. In addition, at least portions of the information processing system 100 may also be referred to herein as collectively comprising one or more “enterprises.” Numerous other operating scenarios involving a wide variety of different types and arrangements of processing nodes are possible, as will be appreciated by those skilled in the art.

The network 106 is assumed to comprise a global computer network such as the Internet, although other types of networks can be part of the network 106, including a wide area network (WAN), a local area network (LAN), a satellite network, a telephone or cable network, a cellular network, a wireless network such as a WiFi or WiMAX network, or various portions or combinations of these and other types of networks.

The servers 104 implement a code execution data store 112, which is configured to store and record various information related to execution of code of the application services 110. For example, the code execution data store 112 may comprise an execution queue of jobs or tasks (e.g., server-side code of the application services 110), an execution result queue of results of execution of the jobs or tasks in the execution queue, logs or telemetry data characterizing how the jobs or tasks in the execution queue were executed (e.g., through offloading of the server-side code execution to the client devices 102), the effectiveness of execution of the jobs or tasks in the execution queue (e.g., by the client devices 102), mappings or associations between jobs or tasks and ones of the client devices 102, information related to available hardware and/or software resources of the client devices 102 which may be used to match the jobs or tasks in the execution queue, etc. In some embodiments, the code execution data store 112 comprises a set of specialized execution queues, where jobs or tasks placed in a general execution queue are segregated or otherwise classified based on their resource needs and other requirements in order to facilitate matchmaking (e.g., between jobs or tasks and the client devices 102).

In some embodiments, one or more storage systems utilized to implement the code execution data store 112 comprise a scale-out all-flash content addressable storage array or other type of storage array. Various other types of storage systems may be used, and the term “storage system” as used herein is intended to be broadly construed, and should not be viewed as being limited to content addressable storage systems or flash-based storage systems. A given storage system as the term is broadly used herein can comprise, for example, network-attached storage (NAS), storage area networks (SANs), direct-attached storage (DAS) and distributed DAS, as well as combinations of these and other storage types, including software-defined storage.

Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

Although not explicitly shown in FIG. 1, one or more input-output devices such as keyboards, displays or other types of input-output devices may be used to support one or more user interfaces to the client devices 102, the servers 104 and other elements of the information processing system 100, as well as to support communication between such elements and other related systems and devices not explicitly shown.

The client devices 102 and the servers 104 in the FIG. 1 embodiment are assumed to be implemented using at least one processing device. Each such processing device generally comprises at least one processor and an associated memory, and implements one or more functional modules or logic for controlling certain features of the information processing system 100. In the FIG. 1 embodiment, the servers 104 implement client-side task offload triggering logic 114, task-to-client device mapping logic 116, and client-side task execution analysis logic 118, while the client devices 102 implement the client-side execution agents 120. The client-side execution agents 120 are configured for automated transmission of information with the servers 104, in order to manage and facilitate the offloading of server-side code execution for the application services 110 to the client devices 102. For example, the requestors 108 may access the application services 110 and request execution of one or more functions thereof. It should be noted that, in some embodiments, the requestors 108 may be the client devices 102 and/or the servers 104 (e.g., such as where the servers 104 seek to offload batch processing jobs or tasks for client-side execution). Such requests trigger the generation of tasks of jobs (e.g., of server-side code to be executed) which are placed in an execution queue (e.g., of the code execution data store 112). Such tasks or jobs may be performed server-side by the servers 104 themselves, or may be “offloaded” for execution client-side by the client devices 102. Advantageously, the entity which executes a given task or job may be different than the entity which requested execution of the given task or job (e.g., a first one of the client devices 102-1 may request execution of a task, with that task being performed server-side by the servers 104 or being offloaded to one or more other ones of the client devices 102-2 through 102-M). The client-side task offload triggering logic 114 is configured to control whether and when the server-side code is offloaded for execution by the client devices 102. For example, the client-side task offload triggering logic 114 may initiate offloading of server-side code for execution by the client devices 102 on determining that the servers 104 are becoming overloaded, that one or more of the servers 104 are offline or down, that specialized resources not available on the servers 104 is needed for execution of one or more tasks in the execution queue, etc.

The task-to-client device mapping logic 116 is configured to match tasks in the execution queue with ones of the client devices 102 which are available and suited for performing the tasks. An enterprise or organization operating the IT infrastructure 101 is assumed to enroll or register the client devices 102 as “volunteers” willing to participate in offloading of execution of the server-side code. Such enrollment or registration includes installing the client-side execution agents 120, and determining the available hardware and/or software resources of the client devices 102 as well as patterns of usage of the client devices 102 (e.g., to determine when the client devices 102 will be idle or otherwise underutilized such that performing execution of server-side code will not disrupt normal use of the client devices 102). The task-to-client device mapping logic 116 can segregate tasks in the execution queue into one or more “specialized” execution queues based on analysis of the code to be executed for the tasks (e.g., code which requires heavy use of memory resources may be placed in a specialized memory execution queue, code which requires use of graphic processing unit (GPU) resources may be placed in a specialized GPU execution queue, code which requires particular licensed software to execute may be placed in a specialized execution queue associated with that licensed software, etc.). The client-side execution agents 120 may poll ones of the specialized execution queues which correspond to the available hardware and/or software resources of the client devices 102, to pull and execute tasks. The client-side execution agents 120 may further post results of task execution into an execution results queue (e.g., of the code execution data store 112), along with logs and/or telemetry data characterizing how well or effective the client devices 102 were in executing the tasks. The requestors 108 may obtain the task execution results from the execution results queue (e.g., either directly, or via responses forwarded from the application services 110).

The client-side task execution analysis logic 118 is configured to analyze the logs and/or telemetry data characterizing how well or effective the client devices 102 were in executing the tasks in order to update algorithms used by the task-to-client device mapping logic 116 in assigning tasks to the client devices 102. In some embodiments, the client-side task execution analysis logic 118 is configured to “test” the capabilities of the client devices 102 by having the client devices 102 execute code samples of different types to determine which types of code the client devices 102 are effective at executing. Such testing may be performed prior to allowing the client-side execution agents 120 of the client devices 102 to pull actual tasks from the execution queue. In some cases, until sufficient data is available regarding the capabilities of the client devices 102, the client devices 102 may be limited to executing certain types of code (e.g., non-critical code).

At least portions of the client-side task offload triggering logic 114, the task-to-client device mapping logic 116, the client-side task execution analysis logic 118, and the client-side execution agents 120 may be implemented at least in part in the form of software that is stored in memory and executed by a processor.

It is to be appreciated that the particular arrangement of the IT infrastructure 101, the client devices 102, the servers 104 and the requestors 108 illustrated in the FIG. 1 embodiment is presented by way of example only, and alternative arrangements can be used in other embodiments. The servers 104 and other portions of the information processing system 100, as will be described in further detail below, may be part of cloud infrastructure.

Various components of the information processing system 100 in the FIG. 1 embodiment, including the client devices 102 and servers 104, are assumed to be implemented using at least one processing platform comprising one or more processing devices each having a processor coupled to a memory. Such processing devices can illustratively include particular arrangements of compute, storage and network resources.

The client devices 102, the servers 104, the requestors 108, the application services 110, the code execution data store 112 or components thereof (e.g., the client-side task offload triggering logic 114, the task-to-client device mapping logic 116, the client-side task execution analysis logic 118, and the client-side execution agents 120) may be implemented on respective distinct processing platforms, although numerous other arrangements are possible. For example, in some embodiments at least portions of one or more of the client devices 102 and one or more of the servers 104 are implemented on the same processing platform.

The term “processing platform” as used herein is intended to be broadly construed so as to encompass, by way of illustration and without limitation, multiple sets of processing devices and associated storage systems that are configured to communicate over one or more networks. For example, distributed implementations of the information processing system 100 are possible, in which certain components of the system reside in one data center in a first geographic location while other components of the system reside in one or more other data centers in one or more other geographic locations that are potentially remote from the first geographic location. Thus, it is possible in some implementations of the information processing system 100 for the client devices 102, the servers 104, the requestors 108, or portions or components thereof, to reside in different data centers. Numerous other distributed implementations are possible. The IT infrastructure 101 can also be implemented in a distributed manner across multiple data centers.

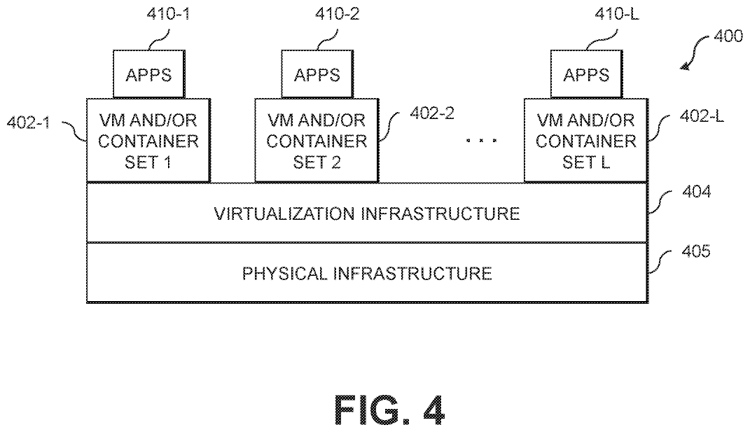

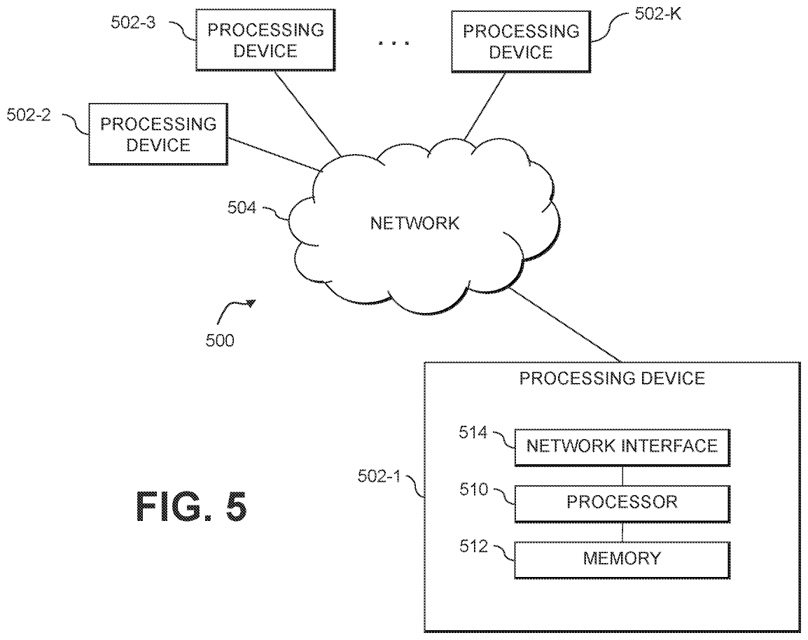

Additional examples of processing platforms utilized to implement the information processing system 100 in illustrative embodiments will be described in more detail below in conjunction with FIGS. 4 and 5.

It is to be understood that the particular set of elements shown in FIG. 1 configured for offloading execution of server-side code to client devices in an IT infrastructure environment is presented by way of illustrative example only, and in other embodiments additional or alternative elements may be used. Thus, another embodiment may include additional or alternative systems, devices and other network entities, as well as different arrangements of modules and other components.

It is to be appreciated that these and other features of illustrative embodiments are presented by way of example only, and should not be construed as limiting in any way.

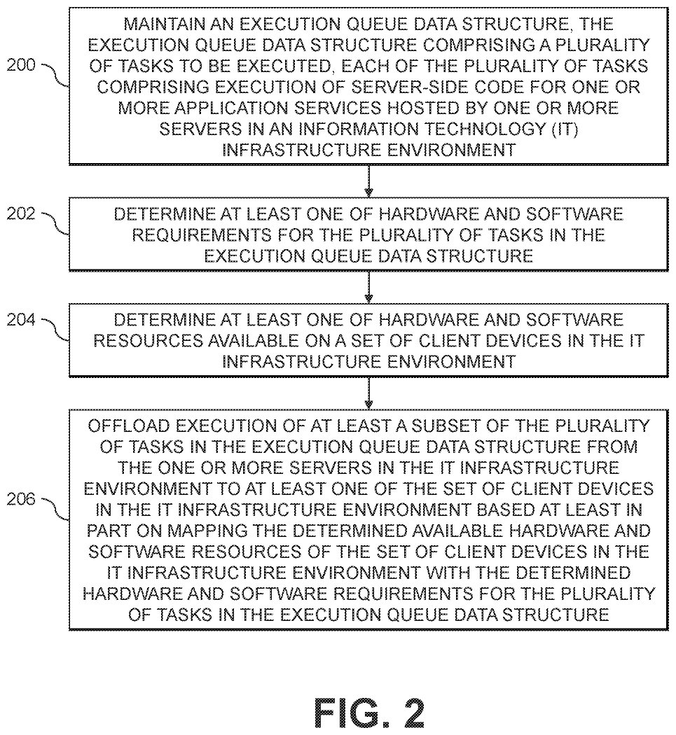

An exemplary process for offloading execution of server-side code to client devices in an IT infrastructure environment will now be described in more detail with reference to the flow diagram of FIG. 2. It is to be understood that this particular process is only an example, and that additional or alternative processes for offloading execution of server-side code to client devices in an IT infrastructure environment may be used in other embodiments.

In this embodiment, the process includes steps 200 through 206. These steps are assumed to be performed by the client devices 102 and the servers 104 of the IT infrastructure 101 utilizing the client-side task offload triggering logic 114, the task-to-client device mapping logic 116, the client-side task execution analysis logic 118, and the client-side execution agents 120. The process begins with step 200, maintaining an execution queue data structure. The execution queue data structure comprises a plurality of tasks to be executed. Each of the plurality of tasks comprises execution of server-side code for one or more application services hosted by one or more servers in an IT infrastructure environment. Maintaining the execution queue data structure may comprise generating two or more specialized execution queue data structures each associated with at least one designated type of hardware or software resources, and placing different subsets of the plurality of tasks into each of the two or more specialized execution queue data structures based at least in part on the determined hardware and software requirements for the plurality of tasks.

In step 202, at least one of hardware and software requirements for the plurality of tasks in the execution queue date structures are determined. Determining the hardware and software requirements for a given one of the plurality of tasks in the execution queue data structure may comprise performing natural language processing (NLP) of the server-side code of the given task utilizing one or more deep learning algorithms. The one or more deep learning algorithms may comprise one or more large language models (LLMs).

In step 204, at least one of hardware and software resources available on a set of client devices in the IT infrastructure environment are determined. Determining the hardware and software requirements for a given one of the tasks may also or alternatively comprise deriving one or more metrics for the server-side code of the given task, the one or more metrics comprising at least one of a time complexity of the server-side code of the given task, a space complexity of the server-side code of the given task, and a cyclomatic complexity of the server-side code of the given task.

Execution of at least a subset of the plurality of tasks in the execution queue data structure is offloaded in step 206 from the one or more servers in the IT infrastructure environment to at least one of the set of client devices in the IT infrastructure environment based at least in part on mapping the determined available hardware and software resources of the set of client devices in the IT infrastructure environment with the determined hardware and software requirements for the plurality of tasks in the execution queue data structure. The set of client devices in the IT infrastructure environment may comprise a subset of a plurality of client devices in the IT infrastructure environment which have client-side execution agents installed therein for facilitating the offload of the execution of said at least a subset of the plurality of tasks in the execution queue data structure from the one or more servers in the IT infrastructure environment.

A given one of the plurality of tasks may be added to the execution queue data structure based at least in part on a request received from a first one of the set of client devices in the IT infrastructure environment, and the execution of the given task may be offloaded to a second one of the set of client devices in the IT infrastructure environment. In some embodiments, a given one of the plurality of tasks is added to the execution queue data structure based at least in part on a request received from a client device external to the IT infrastructure environment, and the execution of the given task is offloaded to a given one of the set of client devices internal to the IT infrastructure environment.

In some embodiments, a given one of the plurality of tasks is added to the execution queue data structure based at least in part on a request received by at least one of the one or more servers, and the execution of the given task is offloaded to at least one of the set of client devices in the IT infrastructure environment. The given task may comprise a batch processing job.

Offloading execution of a given one of the plurality of tasks in the execution queue data structure from the one or more servers in the IT infrastructure environment to at least a given one of the set of client devices in the IT infrastructure environment may be further based at least in part on results of execution of one or more historical tasks by the given client device in the IT infrastructure environment. The one or more historical tasks may comprise previous instances of execution of the same server-side code as the given task, one or more test tasks having code types exhibiting at least a threshold level of similarity to the server-side code of the given task, etc. The results of execution of the one or more historical tasks by the given client device in the IT infrastructure environment may characterize effectiveness of the given client device in executing the one or more historical tasks, the effectiveness being determined based at least in part on at least one of speed of execution of the one or more historical tasks and whether any errors were encountered during execution of the one or more historical tasks.

In the field of web-based development, the boundaries between web servers, application servers, clients and other client devices that might exist on the network of the web servers is very rigid, where every role plays a strict part. The clients, for example, are mainly responsible for initiating requests and getting responses back, while the web servers and/or application servers are responsible for processing the requests, executing server-side code, and sending the responses back to the clients. This means that anytime a lot of processing needs to be done on the web servers and/or application servers, the server-side infrastructure has to scale up to meet this change in processing demand.

Some technologies, such as Web Workers, have been introduced which allow clients to do part of the processing using JavaScript. Other technologies like web assemblies allow clients to execute micro-runtimes inside the web browser, which further increases the scope of capabilities of the clients and allows the clients to run specialized languages (e.g., C#, rust, etc.) on the client-side inside the web browser. However, even in these cases, the clients simply share the processing for their own specific requests. The clients cannot provide processing resources for other requests that might be originating in the system. Some approaches have sought to make specialized attempts for utilizing client-side processors to carry out request processing for a server. For example, the Search for Extraterrestrial Intelligence (SETI) @Home project allows volunteers to opt in to donate specific central processing unit (CPU) cycles to run specialized code that helps the SETI@Home project. As another example, the Berkeley Open Infrastructure for Network Computing (BOINC) project allows for running specific kinds of scientific experiments using shared client-side resources. These and other approaches, however, suffer from various technical challenges due to their rigid design, ability to process only a singular kind of task, and reliance on a singular platform.

Other approaches, such as Apache Spark™, use technologies like Map-Reduce to break a task into smaller tasks which are distributed amongst a set of worker nodes. It is worth noting here that even if the worker nodes are not full-blown servers, they are still implemented as containers on the server side. Even services like Amazon Web Services (AWS) Lambda which are labeled as “serverless” architecture basically still require server-side infrastructure to exist within data centers where the code is executing.

There is thus a need for approaches to run enterprise server-side code and distribute it intelligently amongst clients that might be connected to the server, so that the clients can participate in peer-to-peer (P2P) execution of server loads. The technical solutions described herein provide a novel framework that meets these and other needs. The technical solutions can thus provide various technical advantages, including drastically reducing the server requirements within organizations (e.g., IT infrastructure environments), helping sustainability, providing greater resilience (e.g., as compared to having a fixed set of servers that can go down any time), and providing a rock-solid fallback platform for almost all web development.

In some embodiments, the technical solutions provide a framework that is generic and can work for any enterprise, is capable of running code across languages, is completely zero configuration, is self-evolving and growing, and is self-optimized. The framework can take regular web processing tasks (e.g., that are typically executed server-side) and intelligently route them back to the clients that might be connected to the servers (and that are willing to participate in this processing). Such clients can then execute the code using client-side infrastructure and pass the results back to the servers, which can be used for further processing or which can be passed back to the initiator in the form of regular responses (e.g., hypertext transfer protocol (HTTP) or other suitable response types). The framework used in technical solutions is designed such that a host of languages, technology stacks, etc. can be discovered and categorized. The relevant code and functions can then be executed on the client side without requiring any special maintenance from IT/DevOps departments. Once a client opts in to provide a specific part or portion of their CPU, graphics processing unit (GPU) or other resources for use in P2P execution of server loads, no additional configuration is required on the client side or the server side. The framework may utilize Artificial intelligence (AI) and/or machine learning (ML) to handle routing, distribution and balancing of tasks between the clients and the servers. As clients install more technology stacks and frameworks on their systems, the servers learn these installations and are able to intelligently route relevant code and executables to those clients, resulting in a system that will eventually evolve over time and will require no maintenance and very little server-side power, even to run high-end enterprise systems. As clients are upgraded with newer or additional hardware (e.g., newer random-access memory (RAM), GPUs, etc.), the overall P2P execution framework can leverage such new hardware seamlessly.

In some embodiments, the framework is designed and developed for an enterprise or organization, and can allow enterprises or organizations to set policies where administrators can (if desired) control the scope and magnitude of contributions that clients engage in. Client-side agents, described in further detail below, may utilize AI and/or ML to recognize usage patterns of the clients and their resources (e.g., CPU, RAM, GPU usage, etc.) to decide if the clients can take up tasks seamlessly without impacting the clients' own functioning or any work the clients might already be performing. For example, if a given client device is already occupied with a GPU-intensive task, the given client device may not pick up any tasks which require the use of GPU resources during that time that the GPU-intensive task is being performed. At other times, when the GPU resources are free, the given client may pick up tasks which require the use of GPU resources.

The technical solutions described herein, in some embodiments, provide an AI-powered, fully decentralized, P2P model-based code execution system. The code execution system in some embodiments is able to offload server-side code and execution thereof to various independent and disparate client devices that are interested (e.g., which have signed up, registered, or otherwise indicated an interest in or availability for offloading of server-side code execution) in contributing towards this processing. This may work particularly well for connected client devices in an enterprise or other organization, where such connected client devices can be utilized during times where the connected client devices are idle or underutilized (e.g., are performing less other processing activities). The code execution system is configured to intelligently maintain an inventory of client devices that have expressed interest in contributing towards the processing of server-side code. The code execution system may be configured, for such client devices, to maintain an inventory of their technology stacks, installed frameworks, and the type of code they have been able to execute. This inventory may be maintained at least in part utilizing client-side agent software that is pushed to the client devices.

The code execution system may also be configured to intelligently figure out the best participation scheme for the client devices, based on their free time, low load execution times, and their specialization. The client device “specialization” may exist by virtue of the fact that different client devices may have different specific kinds of available hardware (e.g., volumes of free RAM, certain GPU variants, etc.) and software (e.g., installed code frameworks, software licenses, etc.) resources. The code execution system may further provide data about performance of execution of the code on the client side, so that similar client devices can be picked for future execution. The code execution system may further provide functionality for intelligently parsing code and/or executables to figure out their underlying platform, hardware and software requirements (e.g., based on the underlying application programming interfaces (APIs) used, cyclomatic and time complexity, etc.). The code and/or executables are then classified and are segregated into specific specialized execution queues so that they can be polled and picked up by client-side execution agents in an asynchronous manner. The code execution system also allows the client devices to compile the code (unless the execution units are deployed and distributed as executable binaries like .dll or .jar files) and execute the instructions autonomously. It should be noted, however, that compilation is not necessary for many interpreted languages. Even for languages that do need compilation, pre-compiled packages can be directly pushed to the client devices. The client devices are also allowed to cache compiled version of the code and compare the changes on a server using a simple checksum/hash so that the client devices do not waste excess time compiling the code. The client devices are also able to write results back to result queues, from which the results can be picked up by the servers so that regular execution can be resumed. Once the results reach the servers, they can be further used as inputs for next function execution (e.g., which can again be distributed out to client devices) or can be sent back to the client devices using full-duplex standardized web-based responses (e.g., HTTP or other suitable response types).

The technical solutions described herein advantageously provide a smarter approach towards lowering the server load. This provides a much more sustainable alternative to buying more server hardware every time a system needs to scale. This also allows client devices to become an alternate backup in the case of massive server infrastructure outages (e.g., where entire data centers are down, which can often take applications down). The code execution system may be built in a lightweight multi-cloud environment, where the bulk of processing may be offloaded using the P2P model which is able to withstand complete chaos offering significantly improved resilience. Thus, built-in resilience and redundancy are provided without requiring complex technologies like auto-scaling. Further, the technical solutions allow for lower maintenance and DevOps activities including, but not limited to, server-side patches and application software updates. As more and more client devices pool in to contribute their free processing cycles and update their patches independently, DevOps and maintenance on the server side will be lowered.

Conventional models for software development are subject to various technical challenges. For example, conventional software development models may utilize a singular mindset for scaling. Most server-side infrastructure and cloud environments support two distinct ways of scaling. The first is vertical scaling, where the individual servers are themselves scaled up. The second is horizontal scaling, where more and more containers or servers are added to the data center thereby resulting in scaling of the infrastructure. Essentially, this results in a single approach to scale an application, which is to throw more infrastructure on the server side or the data center. It should be noted that even horizontal scaling eventually requires more physical infrastructure on the server side, which means more investment (and, eventually, more carbon footprint). When this infrastructure is not in use, it lies idle but does not go away.

Another technical challenge with conventional approaches is that potentially massive processing power on the client side is ignored. Web developers, for example, may have a mindset to distinguish and draw hardwired and traditional lines between the “servers” and the “clients,” which leaves a narrow vision of where server-side code should or can be executed. While web developers may seek to get more processing power and capacity on servers at any given time, in most organizations there is a huge number of client devices that may be idle and could be leveraged for the same processing. It has been reported, for example, that most users spend almost a third of their work week reading and responding to email. During this time, the CPUs, GPUs, RAM and network resources of the users' client devices may be grossly underutilized and could be leveraged to execute server-side functions which have been offloaded to the client devices. By drawing stringent boundaries between servers and clients, opportunities for harnessing the processing power of client devices that is lying idle within an organization are missed out on.

Yet another technical challenge is the way that conventional approaches treat resilience and sustainability as a zero-sum game. Web developers, for example, tend to see a zero-sum game between the resilience and the sustainability of a system. Put simply, if it is desired to build a system that keeps running when an application server goes down, the solution is to provision mirror application servers that can take the load if the first one goes down. Traditional load balancing comes at the cost of sustainability. The technical solutions described herein leverage a resilience mechanism that exists in the form of potentially large numbers (e.g., hundreds, thousands, etc.) of client devices that may be connected to the same server and which an organization may be happy to volunteer for helping the server process its load if the situation so demands.

Conventional approaches may also suffer from technical challenges related to either very high specialization, or no specialization. Each web process or other execution job may have its own demands. For example, a web application may have a particular flow that requires 6 gigabytes (GB) of RAM to process, and thus all containers running the web application would need to have 6 GB of RAM since that flow can be invoked at any given time. Similarly, if an application has a job that requires high networking requirements with an external system, the entire server infrastructure has to be provided with high connectivity to that specific external system. On the client side, there may be a variety of client devices (e.g., some with high-performance CPUs, specialized gaming GPUs, with high RAM, with high-speed connections, etc.). By not leveraging this specialized army of what may be referred to as micro-proxy-server-execution agents, conventional approaches end up with either very high-end infrastructures on the server side (e.g., where containers or servers have high RAM, CPU, storage, network connectivity, etc.) or which infrastructures have no specialization on the server side and which opt to buy the specialization separately (e.g., by renting specialized GPU or other resources on cloud computing platforms).

Conventional approaches also suffer from technical challenges in that servers may be used for all processing, even for batch jobs. For example, developers may put themselves in boxes of where each code is executed (e.g., server-side code on servers, client-side HyperText Markup Language (HTML) and scripts on the client side) and are forever limited by this mindset. This often results in developers executing server-side batch jobs on expensive and specialized server hardware. Such batch jobs are not real time, and do not have to provide any feedback to the client devices such that there is virtually no reason for these jobs to be executed on expensive server-side hardware. Conventional approaches, however, rely on expensive server-side hardware for executing batch jobs.

Additional technical challenges relate to server-side licensing costs. In most software development environments, multiple applications have to be installed in development and production environments separately. Take, for instance, a piece of code that converts HTML to Portable Document Format (PDF). Assuming that this code requires a third-party license for a software that converts HTML to PDF, the developers will need to buy a license for the code for use in the development environment. Once developed, the same license will also have to be bought on the server side for the production environment. A similar license may need to be available in the User Acceptance Testing (UAT) environment as well. At any given time, if the conversion between HTML and PDF can be done in the background, this task can be completely offloaded to client devices, where the framework can match the task with client devices that have a relevant license and/or application for running the code. Such dependencies may, for example, be discovered using NuGet tracing.

In some embodiments, a distributed processing framework for a serverless architecture is provided which allows server-side code to be executed on one or more client devices that may be directly, remotely or indirectly connected to one or more servers (e.g., web servers, application servers, etc.). Code that is to be executed server-side may be packaged into a code manifest, or a compiled binary with execution metadata, and is passed on to the client devices using a messaging queue. Client-side agents running on the client devices download the code manifests, execute them using the server's runtime and using hardware and software installed on the client devices.

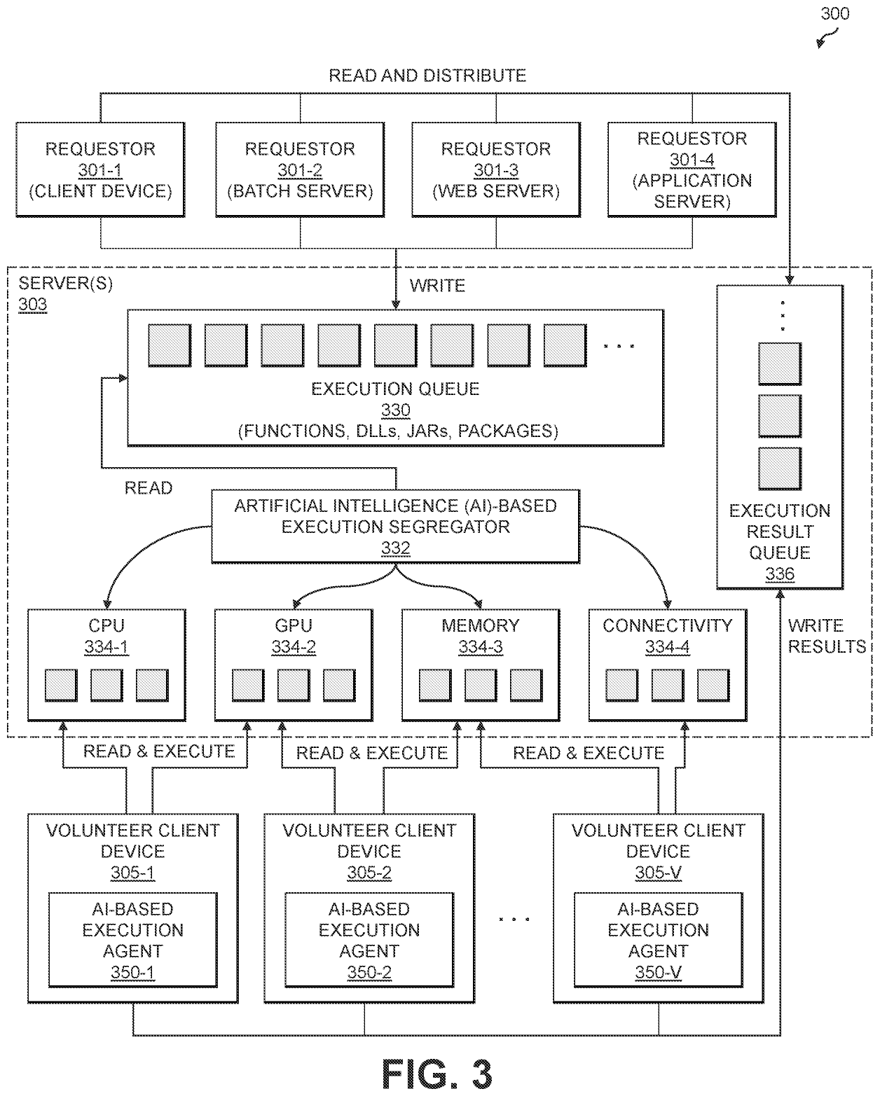

FIG. 3 shows a system 300 implementing a distributed processing framework for a serverless architecture. The system 300 includes a set of requestors 301-1, 301-2, 301-3 and 301-4 (collectively, requestors 301), server-side infrastructure including one or more servers 303 implementing an execution queue 330, AI-based execution segregator 332, CPU queue 334-1, GPU queue 334-2, memory queue 334-3, and connectivity queue 334-4 (collectively, specialized execution queues 334), and an execution result queue 336, and client-side infrastructure including a plurality of volunteer client devices 305-1, 305-2, . . . 305-V (collectively, volunteer client devices 305) implementing AI-based execution agents 350-1, 350-2, . . . 350-V (collectively, AI-based execution agents 350).

The requestors 301 are entities which request execution of jobs or tasks (e.g., execution of code functions) on the servers 303. The servers 303 are configured to implement a framework for offloading execution of such jobs or tasks to the volunteer client devices 305, which are clients on a network which have volunteered (e.g., registered or otherwise indicated an interest in) being part of a decentralized, P2P model-based code execution system which allows server-side code to be offloaded from the servers 303.

The requestors 301 are configured to write jobs to the execution queue 330, where the jobs may be functions, DLLs, JARs, packages, etc. Some of the requestors 301 may be “servers” themselves (e.g., requestor 301-2 which is a batch server, requestor 301-3 which is a web server, and requestor 301-4 which is an application server, where such servers may be one of the servers 303). One or more of the requestors 301 may be clients on the network (e.g., requestor 301-1 which is a client device, which may be one of the volunteer client devices 305 or other non-volunteer client devices). For example, a data analyst may utilize a client device (e.g., the requestor 301-1) to run a data science, AI or ML experiment or process that requires significant resources (e.g., a large number of CPUs). The data analyst can utilize the requestor 301-1 to package the code for running the data science, AI or ML process as one or more functions (e.g., Python functions) and utilize a requestor software development kit (SDK) to have the packaged code added to the execution queue 330. Similar processing happens in web applications that need to execute a backend job (e.g., in real-time, as a patch, etc.). The web application (e.g., the requestor 301-3 which is a web server) can package the code (or a binary with execution metadata) and have it added to the execution queue 330 using the requestor SDK. Once added to the execution queue 330, a listener becomes instantly aware of the addition and triggers the AI-based execution segregator 332.

When jobs are placed in the execution queue 330, the jobs will either have code or metadata associated with the code to be executed. The AI-based execution segregator 332 is configured to understand the code (e.g., using one or more large language models (LLMs) or other deep learning algorithms configured to perform natural language processing (NLP) tasks on the code and/or metadata) and derive metrics therefrom. The metrics, for example, may include time complexity metrics, space complexity metrics, cyclomatic complexity metrics, etc. Based on these metrics and code patterns, the AI-based execution segregator 332 is able to differentiate and categorize the code to place the code in different ones of the specialized execution queues 334 (e.g., based on the resources required for execution of the code). For example, code that requires heavy CPU usage is placed in CPU queue 334-1, code that requires use of specialized GPUs is placed in GPU queue 334-2, code that requires heavy use of RAM (e.g., high space complexity) is placed in memory queue 334-3, code that requires high network usage is placed in connectivity queue 334-4, etc. The CPU queue 334-1, GPU queue 334-2, memory queue 334-3 and connectivity queue 334-4 are non-limiting examples of requirement-based or specialized execution queues.

Once the AI-based execution segregator 332 has separated out the code and used the code and any associated metadata to analyze the underlying infrastructure requirements for executing the code, it starts moving the code/execution messages from the execution queue 330 to the specialized execution queues 334 (e.g., CPU queue 334-1, GPU queue 334-2, memory queue 334-3, connectivity queue 334-4, etc.). It should be noted that specialized execution queues may be created dynamically if a needed specialized execution queue for a given piece of code does not already exist. In some embodiments, the specialized execution queues represent specific infrastructure requirements. For example, the system 300 might have three different specialized execution queues for memory (e.g., medium, high, extremely high) and, depending on the space complexity of the code, the code may be moved to one of the different specialized memory execution queues. Similarly, one or multiple specialized execution queues may be created for CPU and anything that has high time complexity or high cyclomatic complexity but a lower space complexity. In some embodiments, one or more specialized execution queues may combine different types of specialized infrastructure requirements (e.g., a specialized execution queue for code that requires both high RAM and high CPU, a specialized execution queue for code that requires high CPU and high connectivity, etc.). Specialized execution queues may also be created for code which requires specific types of software (e.g., licensed software) in order to be executed. The system 300 may create individual specialized execution queues based on specialized hardware and/or software requirements needed for execution of different pieces of code. The volunteer client devices 305 can “listen” to the different specialized execution queues 334, and can take on jobs for which the volunteer client devices 305 are suitable for.

The volunteer client devices 305, as discussed above, are client devices or machines that have committed to contribute or help in execution cycles for jobs placed in the execution queue 330 by the requestors 301. A client device may be considered a “volunteer” and join the set of volunteer client devices 305 if various requirements are met. Such requirements may include, for example, that the client device has a client-side AI-based agent (e.g., an instance of the AI-based execution agent 350) running thereon. Each client device that wants to participate should download an executable/service (e.g., an instance of the AI-based execution agent 350) and have it running at all times in which it is willing to participate in the decentralized P2P model-based code execution system. The role of the client-side agent is a specialized one, and will be discussed in further detail below. The requirements may also include configuration requirements. For example, end-users of the volunteer client devices 305 may establish manual limits which are enforced by the AI-based execution agents 350. Such limits, for example, may state how much of the resources of the volunteer client devices 305 may be utilized for execution of server-side jobs from the execution queue 330. For example, even if a given one of the volunteer client devices 305-1 is “free” it may not necessarily pick up a particular job or task in the execution queue 330. For example, the AI-based execution agent 350-1 of the volunteer client device 305-1 may be configured such that only 30% of the volunteer client devices 305-1's CPU resources can be used for processing of jobs or tasks offloaded from the servers 303. If the AI-based execution agent 350-1 determines that 50% of the CPU resources of the volunteer client device 305-1 would be need for a given task in the execution queue 330, then the AI-based execution agent 350-1 will not allow the given task to be picked up by the volunteer client device 305-1 even if 100% of its CPU resources were currently idle.

The AI-based execution agents 350 of the volunteer client devices 305 will read and execute jobs from the specialized execution queues 334 (e.g., by listening to or polling ones of the specialized execution queues 334 associated with hardware and/or software requirements which match the configurations of the volunteer client devices 305). When the AI-based execution agents 350 of the volunteer client devices 305 execute code, or run compiled functions inside an assembly, it typically comes out with a data structure including results of such execution. Serialized (e.g., binary or otherwise) versions of the result sets are then written into the execution result queue 336. These results wait in the execution result queue 336 for the servers 303 to pick them up and pass them back to the initial requestor (e.g., the one of the requestors 301 which placed the job in the execution queue 330). Each message in the execution result queue 336 may include three aspects: results, logs and telemetry. The results are the actual serialized result obtained from code execution. The logs are generated from the code execution, and can later help in understanding and analyzing which of the volunteer client devices 305 that the code ran on and debug any issues that might exist. The telemetry may primarily focus on the data of the quality of execution (e.g., how fast the code ran, if the code ran with zero errors, etc.). The speed of execution is sent back to a database, so that the system 300 can evaluate the quality of the relationship between the code and the executing one of the volunteer client devices 305. If a given one of the volunteer client devices 305 produces “clean” telemetry data, this may mean that the given one of the volunteer client devices 305 will be considered a preferred one of the volunteer client devices 305 for running another instance of the same code, or instances of different but similar code.

The servers 303 may implement execution queue listeners (not shown in FIG. 3) which are configured to monitor the execution result queue 336. As soon as a result hits the execution result queue 336, the agents (e.g., which may work using sockets which are left open for the result) can instantly listen to the response, pick up the response from the execution result queue 336, and place it back on the socket so that the invoker (e.g., the one of the requestors 301 which placed the corresponding job in the execution queue 330) gets the result back. This allows for both an eventing-based design as well as emulation for a classic web-based full duplex design where each request results in a response and hence code execution on the servers 303 using this complex architecture is no different, from the perspective of a programmer or other end-user, from simply calling an API of the servers 303.

Additional details regarding various components of the system 300 will now be described. On the server side, various ones of the requestors 301 have access to write tasks or jobs to the execution queue 330. In some embodiments, the requestors 301 may write compiled binaries with interface-implemented entry points and a manifest. The requestors 301 may also or alternatively write functional code (e.g., functions, classes, etc.) with finite entry points and runtime parameter values (e.g., a function with a public static void main that invokes that function). At the foundational level, the AI-based execution segregator 332's role is to pick up the jobs or tasks in the execution queue 330 (e.g., binaries with manifests, code snippets, etc.) and will:
1. Use the manifest data to figure out underlying dependencies and maintain a dependency list (e.g., to later match with ones of the volunteer client devices 305 that might have the required dependencies).
2. Analyze the manifest to figure out the generic platform requirements for running the code.
3. Calculate code metrics (e.g., time complexity, space complexity, cyclomatic complexity, etc. of the code).
4. Use one or more AI/ML-based similarity algorithms to figure out similar code that was moved to respective specialized execution queues in the past and which were executed efficiently.
5. Use one or more AI/ML-based algorithms to ascertain if specific code will require a specific quantity and type of hardware resources (e.g., analyzing the code to see if it is doing anything with images and is in python such that the code would most likely benefit from use of GPU resources, a higher space complexity means that the code would most likely benefit from use of more RAM resources, a higher time complexity means that the code would most likely benefit from use of more CPU resources, higher IO functions means that the code would most likely benefit from use of faster SSD resources for temporary writing which might be needed, higher presence of network API calls such as System.NET in C# or the socket module in Python means that the code would most likely benefit from the use of fast network resources, etc.).
6. In a case where the exact same manifest/code was executed perfectly in the past on a given one of the volunteer client devices 305, device metadata may be appended on the message so that the selection of the volunteer client devices 305 can be at least slightly biased towards selection of the given one of the volunteer client devices 305, if available when this code is in the execution queue 330.
7. Break down the code into two structures-supporting code and execution code, where the supporting code contains functions that support the execution and the execution code contains the main entry point that runs (e.g., the main function with a function call which has specific runtime values passed to the function that the requestor may have coded).
8. The supporting code is hashed, and this hash is persisted to ensure that if a specific subset of the volunteer client devices 305 already have a compiled version of the supporting code and the hash has not been changed, that subset of the volunteer client devices 305 can be preferred to skip any compilation steps that might exist.
9. Segregate and bundle up all items in the execution queue 330 based on the above found data and meta-data into the specialized execution queues 334 (e.g., CPU queue 334-1, GPU queue 334-2, memory queue 334-3, connectivity queue 334-4, etc.) from which the volunteer client devices 305 can pick up the code and execute it.
10. Wait and watch the execution result queue 336 to further update the telemetry and execution data for feedback (e.g., to neural networks or other AI/ML algorithms described above and elsewhere herein).
   It should be noted that the server-side elements of the design of the system 300 may also maintain sample code for each of the specialized execution queues 334 in a library which can be used for “test runs” on the volunteer client devices 305 to ascertain the capabilities and profile each of the volunteer client devices 305 before the volunteer client devices 305 participate in executing or running actual code from the execution queue 330.

The AI-based execution agents 350 may be implemented as executables, which may be written in any suitable low-level language like C++, Rust, etc. The AI-based execution agents 350 may be either directly downloaded by the volunteer client devices 305 (e.g., when such devices are enrolled as volunteers), or may be installed by IT staff or an enterprise or other organization responsible for managing an IT infrastructure environment in which the client devices are deployed. The AI-based execution agents 350 may have associated configurations which specify:
1. High thresholds (e.g., percentages) of free RAM, CPU, GPU, bandwidth and storage resources which can be utilized for shared processing (e.g., where a 100% threshold for a given resource type means that 100% of free resources of the given resource type may be utilized for shared processing).
2. Any other exceptions that need overrides (e.g., “except when a particular application is executing,” “except during a specified time range,” etc.).
3. A pre-collected cache (e.g., which may be created during installation) of frameworks and software installed on the device.
   Once configured, the AI-based execution agents 350 may start to:
1. Track usage of the volunteer client devices 305 to determine the usage of various different types of resources thereof over time, including usage of the different types of resources when specific executables are running, and use such information for training local AI/ML models to predict the times that the volunteer client devices 305 will be “free” or otherwise available for offloading server-side code execution.
2. Start polling a library of sample code and tasks, and execute them to profile what category or categories of code that the volunteer client devices 305 can run effectively. For example, if a RAM-intensive code runs slowly on a given one of the volunteer client devices 305 compared to an expected execution time stored in the library, the given one of the volunteer client devices 305 will flag that code “off” so that similar code will not by pulled by the given one of the volunteer client devices 305 from the execution queue 330 (or from one or more of the specialized execution queues 334). Over a period of time, a profile is built for each of the volunteer client devices 305 which contains the kinds of resources that each of the volunteer client devices 305 has and the kind of code that each of the volunteer client devices 305 might be able to run effectively.
3. With this in place, the AI-based execution agents 350 can gradually pull real tasks marked as non-critical and execute those. Each successful execution is used as reinforcement. For example, if a given one of the volunteer client devices 305 runs a non-critical code written in Python 3.x successfully, then a given one of the AI-based execution agents 350 running on the given one of the volunteer client devices 305 will know that it can now try to run critical Python 3.x code with similar dependencies.
4. As a subset of the volunteer client devices 305 run more code of a specific kind, their AI-based execution agents 350 can develop or learn a “specialization” that the subset of the volunteer client devices 305 can run that kind of code.
5. Each run produces results which are written the execution results queue 336, along with logs of the run which are packaged in a result log queue (e.g., within the execution results queue 336) and telemetry data which indicates how fast the code ran and how effective the execution was.
6. Listeners on the servers 303 and/or the requestors 301 listen to the execution result queue 336 and have access to the results and their associated logs and telemetry data. The telemetry data may be used to introduce bias for routing of future tasks/jobs (e.g., to route or not route the future tasks/jobs to the same volunteer client devices 305, if available, based on how fast or effectively the volunteer client devices 305 performed similar historical tasks/jobs). For example, consider a task T1 that has been executed successfully multiple times on a laptop L1, and that another instance of the task T1 has been published to the execution queue 330. A “preferred_device” flag on the message may contain or specify L1 and a “compatibility_score” (e.g., a number between 1 and 10) illustrating the effectiveness of previous runs of the task T1 on the laptop L1. If the laptop L1 is available and polling, it may pick up tasks from the execution queue 330 which have been flagged for it with high compatibility scores.

It should be noted that, in some embodiments, the AI-based execution agents 350 may provide details about the frameworks and licensed software installed therein. Such details may be provided as part of the telemetry data. Thus, similar volunteer client devices 305 may be flagged as such on the server-side. For example, if L1 and L2 are identical laptops (e.g., a same hardware model with the same or similar software running thereon), if a job or task has been run effectively on L1 but if L1 is reporting itself as busy, then L2 might be pushed into the “preferred_device” flag. If none of the preferred devices are online/available, any suitable one of the volunteer client devices 305 may pick up the job or task and the evaluation process can begin all over again.

The technical solutions described herein provide a number of technical advantages, including by providing a code execution framework which can blur the boundaries between where server-side code is actually executed. Smart execution elements and components provide a number of technical advantages, including:
1. Providing a code execution framework that can utilize client-side hardware for execution of server-side code: In the web development world, conventional approaches have distinct boundaries between which code executes on the client and which code executes on the server. While the clients often execute code like JavaScript, execution of server-side code is often confined to web servers and/or application servers. Thus, in conventional approaches, the generic execution and distribution of web processes generally happens on the server side. Illustrative embodiments provide a more general-purpose code execution framework that is configured to execute any tasks, on any platform, requiring any hardware (e.g., CPU, RAM, GPU, temporary storage, etc.), where the framework matches tasks with volunteer client devices that have the required resources.
2. Providing real-time matchmaking of tasks and volunteer client devices: The technical solutions described herein are configured to utilize AI and/or ML algorithms to identify which tasks require which kinds of resources on server-side agents. Similarly, AI and/or ML algorithms may be used on the client side to figure out which volunteer client devices have the appropriate resources available. An overlay of usage patterns for the volunteer client devices can be used to decide if resources can be safely made available to tasks (e.g., without disrupting how the volunteer client devices are typically utilized by end-users thereof). If there is a match, a volunteer client device may be “introduced” to the task and is allowed to execute the task for one or more runs to see if the volunteer client device is a natural fit for the task. Thus, AI/ML-based matchmaking may be used to match tasks that need to run with available ones of a set of volunteer client devices, where such matchmaking is done in real time.
3. Providing deeper relationships with longer association: Taking the matchmaking analogy above to the next level, AI/ML algorithms both on the client side and the server side may be reinforced with each successful run. This means that if a task was matched to a given volunteer client device on the network and if the given volunteer client device was able to pick up the task and execute it successfully, from a dating analogy this can be seen as a “successful date” and will encourage the next instance of the same task to run on the same volunteer client device, if available, for the next run. Each run further reinforces the allocation agent on the server side and the AI-based execution agent on the client side to run more and more instances of that task. The longer the association between the server-side task and the client-side volunteer device and the longer they remain on the network, the deeper the relationship between the two and the higher the probability of the task running on the given volunteer client device.
4. Determining multi-factored relationships between tasks and volunteer client devices: The technical solutions may algorithmically and heuristically match volunteer client devices that would be best suited to run specific tasks. It is recognized, however, that like any AI/ML-based initiative, these relationships are non-supervised and uncontrolled. For example, consider a network N that has two desktops D1 and D2. While D1 may have a better hardware configuration than D2, there may be a task T1 that always needs to run at a specific time (e.g., 1:00 PM) when D1 is busy executing a batch job of its own. Thus, the task T1 may automatically build a stronger association with D2 than D1. In this case, if D1 is available for a day, the task T1 may not necessarily be routed to it as a first preference. However, if the batch job on D1 stops running for a few days, a new association may be formed with D1 and D2 may be moved to a second priority. It should be noted that such relationships are allowed to evolve naturally based on multi-factored analysis controlled by trained AI/ML algorithms.
5. Providing multi-platform support and lower license cost: The very fact that the server-side code directly executes on the volunteer client devices means that the server-side code can leverage all installations that exist on the client side. For example, if a specific version of Python is required to run a task, that task can be executed on any of the volunteer client devices that have that specific version (or a higher version) of Python installed thereon. This means that the tasks of installing and managing software on the server side (e.g., including applying patches and/or upgrades) no longer become a dedicated task for IT teams. In an enterprise or other organization, for example, as software is installed and managed on client device user environments, that software can be used to execute server-side code. This also provides benefits of lower license costs (e.g., if specialized software is needed for a task and that software happens to be installed and running on one or more volunteer client devices, then server licensing costs for that software can be avoided altogether).
6. Enabling sustainable capacity planning: In conventional approaches, server capacity planning has a direct and linear correlation with hardware required to run tasks and does not take into consideration at all the client devices that might be running on the same network. The technical solutions described herein are able to avoid auto-scaling on the server side (even when such options exist) by offloading some of the tasks to volunteer client devices which might be otherwise running on the client side of the same network. This results in lower infrastructure costs and also a more sustainable approach to running code.
7. Providing massive resilience: As more and more code execution is pushed to the client side, the AI-based execution agents will have the ability to pull, compile and run microservice code onto themselves over tunneled network ports. When this happens, the technical solutions can provide a massively democratized, P2P-based system within an enterprise or other IT infrastructure environment that might be able to run even if most of the servers running most of the microservices suffer an outage. Even in its early stages, the technical solutions provide the ability to run tasks (e.g., critical functions) on the client side to provide a layer of resilience. As mentioned above, auto-scaling on the server side may be performed only if there are no suitable volunteer client devices available on the network. The other way around can also be true, meaning that server-side execution agents may be configured to have higher priority but if for whatever reason they are not available, then client-side execution agents become available for “matchmaking” to offload code execution to the client side. Thus, parts of the service can remain functional even if the servers or data center hosting the service is going through a complete outage and no other backup clusters or server-side infrastructure is available.

Various use case examples will now be described, highlighting how the technical solutions described herein can be implemented in real-world scenarios to save costs while at the same time promoting sustainability.

### Example 1

A web application deployed on a physical server S1 of a data center generates a heavy PDF file with quotes that are sent out to a customer. The process of generating the PDF file includes getting product information from several microservices, calculating prices, and generating the PDF file which is then sent to customers via a back-end job which routes emails via organizational email servers. In the Asia-Pacific (APAC) region, invoices may be scheduled to go out every day at midnight India time. During this time, a lot of developers working in a Texas office may have powerful laptops on. At any given time, some percentage of those developers (e.g., 25%) may be on a call, reading or answering emails, or doing some basic web browsing which are not resource-intensive tasks. An enterprise configuration may enroll such laptops as volunteer client devices. Now, instead of processing the job server-side, multiple (e.g., 5) instances of the same code may be put on an execution queue from which they are moved to specialized execution queues (e.g., in this case, a queue which specifies that volunteers need high connectivity and RAM to get the details from other microservices and generate the massive PDF file in memory). Different volunteer client devices on the network (e.g., ones of the volunteer client devices which are idle or performing tasks which are not resource-intensive as discussed above) pick up the job instances, process the job, and directly distribute the emails to the customers (e.g., by making Simple Mail Transfer Protocol (SMTP) requests to enterprise email servers). Any issues in sending the emails are logged, with the logs being sent back to the log queue and the jobs (e.g., that fail if the mail server is down) are kept back on the specialized execution queue to be picked by a different client to be tried next time around. This automatically ensures: (1) load distribution amongst clients performing the job; (2) resilience and retries; (3) lesser server-side scaling; and (4) better utilization of client-side resources since the volunteer client devices are already active. It should also be noted that, since this job runs every day over a period of time, the laptops that have recurring calls at the same time of the day or users who have a habit of checking emails at that time of the day automatically “bond” together and establish a strong peer-working-relationship to send out these emails. If for some reason one of the laptops or users' behavior changes for a few days and their laptop is not able to pick up the request, alternate laptops on the network pick it up. This strong bonding over time, which may be purely based on a neural network, reflects the proverbial neuro-science approach in which the human brain works (e.g., neurons that fire together wire together, while neural pathways that are not used often wither).

### Example 2

An application running on a cloud instance often sees heavy load. The application involves microservice orchestration required to bring a functional complex shopping cart to life in an e-commerce website (e.g., selling computer hardware, servers, laptops, etc.). Assume that 9 out of 10 servers running the website have been having issues and are down, and that the existing singular “alive” server is unable to process the load. The system realizes this and silently starts to put jobs on the execution queue from which they are eventually picked up by volunteer client devices, processed, and returned. The system exhibits extreme dynamic resilience by flipping to a P2P model from a server-client model based on past intelligence already gathered. The system does so at no extra cost to the organization, and with no negative impact to suitability and with no need to procure additional hardware.

### Example 3

An organization has been considering buying high-end GPUs for their AI department that needs to run training for their AI-based models at a specific time (e.g., in the afternoon). During this time, a bunch of graphic designers of the organization who already have high-end GPUs on their client devices are often in meetings or on calls. Once these jobs are placed on an execution queue, they may be matched with these specific client devices (which are assumed to be enrolled by the organization as volunteer client devices). Since they are not the same network, and they are high-end machines responsible for rendering ultra-high definition (HD) videos with multiple layers, they are easily able to run an image classification training on one or more neural networks. The graphic designers are completely unaware of this, but their client devices may be automatically picked, matched to the requirement, and used to provide a service to the data science department within the organization.

### Example 4

An IT department of an organization has moved the bulk of their processing to the cloud. The organization has a multi-cloud setup, where the organization maintains two equally strong cloud providers to make sure that if a data center goes down or an outage occurs with one of the cloud providers the other one should be able to handle requests. The organization may discover (e.g., using a chaos test) that even if an entire primary provider is down and most of the secondary provider is down, the system performance may be maintained by switching to a P2P code execution mode and intelligently identifying the right clients that are available and capable of running the required code. With this knowledge in mind, the organization may be able to do a sizable reduction in their backup cloud provider and know that the backup cloud provider does not have to be as strong as the primary cloud provider since in case of any outage the system will scale using a smart P2P code execution model.

As discussed above, the technical solutions described herein provide various benefits including lowering auto-scaling on the server side since processing may be outsourced to the client side, providing better sustainability as an organization can procure lesser server-side infrastructure, and reducing costs (e.g., as less server-side infrastructure needs to be procured). In some cases, the technical solutions can provide for faster execution of code. For example, given that server-side containers may be limited in RAM capability and CPU resources, the volunteer client devices which may be picked using an AI/ML-based matchmaking process to run specific code might actually be much more optimized and closer to the source service than the server-side containers. The technical solutions can further provide better resilience, even if the P2P client-side code execution framework is not activated at all times. Once the code execution framework gathers enough intelligence, it can be kept in a stage where it is matching code execution tasks to client-side devices even if the code execution tasks are actually executed server-side. In either case, the system will provide automatic resilience even if the bulk of the server-side infrastructure required to run an application goes down. The intelligent matchmaking between code that is generally executed and the client-side devices that are optimized to run the code will provide sufficient and sometimes better performance than server-side infrastructure (e.g., cloud containers). As more client devices join as volunteers, the system can actually be much faster than an auto-scaled container orchestration cluster (e.g., Kubernetes cluster of, for example, 10 containers).

The technical solutions described herein may provide benefits for any enterprise or other organization that has access to a fleet of unused or underutilized client-side devices. The fleet of unused or underutilized client-side devices may run a variety of code in different languages, and is thus suitable for offloading at least some of the server-side code execution to the client side. The technical solutions described herein can also provide an implementation where web applications can be run entirely, or almost entirely, on a fully distributed P2P grid of volunteer client devices, where the “peers” (e.g., the volunteer client devices) are not simply enrolled but which are intelligently selected using AI/ML-based matchmaking processes which match the right code to the right peers on which the code can be executed effectively. This can lead to changes in the fundamental course of how web applications, for example, are written, deployed and executed.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

Illustrative embodiments of processing platforms utilized to implement functionality for offloading execution of server-side code to client devices in an IT infrastructure environment will now be described in greater detail with reference to FIGS. 4 and 5. Although described in the context of system 100, these platforms may also be used to implement at least portions of other information processing systems in other embodiments.

FIG. 4 shows an example processing platform comprising cloud infrastructure 400. The cloud infrastructure 400 comprises a combination of physical and virtual processing resources that may be utilized to implement at least a portion of the information processing system 100 in FIG. 1. The cloud infrastructure 400 comprises multiple virtual machines (VMs) and/or container sets 402-1, 402-2, . . . 402-L implemented using virtualization infrastructure 404. The virtualization infrastructure 404 runs on physical infrastructure 405, and illustratively comprises one or more hypervisors and/or operating system level virtualization infrastructure. The operating system level virtualization infrastructure illustratively comprises kernel control groups of a Linux operating system or other type of operating system.

The cloud infrastructure 400 further comprises sets of applications 410-1, 410-2, . . . 410-L running on respective ones of the VMs/container sets 402-1, 402-2, . . . 402-L under the control of the virtualization infrastructure 404. The VMs/container sets 402 may comprise respective VMs, respective sets of one or more containers, or respective sets of one or more containers running in VMs.

In some implementations of the FIG. 4 embodiment, the VMs/container sets 402 comprise respective VMs implemented using virtualization infrastructure 404 that comprises at least one hypervisor. A hypervisor platform may be used to implement a hypervisor within the virtualization infrastructure 404, where the hypervisor platform has an associated virtual infrastructure management system. The underlying physical machines may comprise one or more distributed processing platforms that include one or more storage systems.

In other implementations of the FIG. 4 embodiment, the VMs/container sets 402 comprise respective containers implemented using virtualization infrastructure 404 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 400 shown in FIG. 4 may represent at least a portion of one processing platform. Another example of such a processing platform is processing platform 500 shown in FIG. 5.

The processing platform 500 in this embodiment comprises a portion of system 100 and includes a plurality of processing devices, denoted 502-1, 502-2, 502-3, . . . 502-K, which communicate with one another over a network 504.

The network 504 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 502-1 in the processing platform 500 comprises a processor 510 coupled to a memory 512.

The processor 510 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU) or other type of processing circuitry, as well as portions or combinations of such circuitry elements.

The memory 512 may comprise random access memory (RAM), read-only memory (ROM), flash memory or other types of memory, in any combination. The memory 512 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 502-1 is network interface circuitry 514, which is used to interface the processing device with the network 504 and other system components, and may comprise conventional transceivers.

The other processing devices 502 of the processing platform 500 are assumed to be configured in a manner similar to that shown for processing device 502-1 in the figure.

Again, the particular processing platform 500 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for offloading execution of server-side code to client devices in an IT infrastructure environment as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, IT assets, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. An apparatus comprising:
at least one processing device comprising a processor coupled to a memory;
the at least one processing device being configured:
to maintain an execution queue data structure, the execution queue data structure comprising a plurality of tasks to be executed, each of the plurality of tasks comprising execution of server-side code for one or more application services hosted by one or more servers in an information technology infrastructure environment;
to determine at least one of hardware and software requirements for the plurality of tasks in the execution queue data structure;
to determine at least one of hardware and software resources available on a set of client devices in the information technology infrastructure environment; and
to offload execution of at least a subset of the plurality of tasks in the execution queue data structure from the one or more servers in the information technology infrastructure environment to at least one of the set of client devices in the information technology infrastructure environment based at least in part on mapping the determined available hardware and software resources of the set of client devices in the information technology infrastructure environment with the determined hardware and software requirements for the plurality of tasks in the execution queue data structure.

2. The apparatus of claim 1 wherein determining the hardware and software requirements for a given one of the plurality of tasks in the execution queue data structure comprises performing natural language processing (NLP) of the server-side code of the given task utilizing one or more deep learning algorithms.

3. The apparatus of claim 2 wherein the one or more deep learning algorithms comprise one or more large language models (LLMs).

4. The apparatus of claim 1 wherein determining the hardware and software requirements for a given one of the tasks comprises deriving one or more metrics for the server-side code of the given task, the one or more metrics comprising at least one of a time complexity of the server-side code of the given task, a space complexity of the server-side code of the given task, and a cyclomatic complexity of the server-side code of the given task.

5. The apparatus of claim 1 wherein a given one of the plurality of tasks is added to the execution queue data structure based at least in part on a request received from a first one of the set of client devices in the information technology infrastructure environment, and wherein execution of the given task is offloaded to a second one of the set of client devices in the information technology infrastructure environment.

6. The apparatus of claim 1 wherein a given one of the plurality of tasks is added to the execution queue data structure based at least in part on a request received from a client device external to the information technology infrastructure environment, and wherein execution of the given task is offloaded to a given one of the set of client devices internal to the information technology infrastructure environment.

7. The apparatus of claim 1 wherein a given one of the plurality of tasks is added to the execution queue data structure based at least in part on a request received by at least one of the one or more servers, and wherein execution of the given task is offloaded to at least one of the set of client devices in the information technology infrastructure environment.

8. The apparatus of claim 7 wherein the given task comprises a batch processing job.

9. The apparatus of claim 1 wherein offloading execution of a given one of the plurality of tasks in the execution queue data structure from the one or more servers in the information technology infrastructure environment to at least a given one of the set of client devices in the information technology infrastructure environment is further based at least in part on results of execution of one or more historical tasks by the given client device in the information technology infrastructure environment.

10. The apparatus of claim 9 wherein the one or more historical tasks comprise previous instances of execution of the same server-side code as the given task.

11. The apparatus of claim 9 wherein the one or more historical tasks comprise one or more test tasks having code types exhibiting at least a threshold level of similarity to the server-side code of the given task.

12. The apparatus of claim 9 wherein the results of execution of the one or more historical tasks by the given client device in the information technology infrastructure environment characterize effectiveness of the given client device in executing the one or more historical tasks, the effectiveness being determined based at least in part on at least one of speed of execution of the one or more historical tasks and whether any errors were encountered during execution of the one or more historical tasks.

13. The apparatus of claim 1 wherein maintaining the execution queue data structure comprises:
generating two or more specialized execution queue data structures each associated with at least one designated type of hardware or software resources; and
placing different subsets of the plurality of tasks into each of the two or more specialized execution queue data structures based at least in part on the determined hardware and software requirements for the plurality of tasks.

14. The apparatus of claim 1 wherein the set of client devices in the information technology infrastructure environment comprises a subset of a plurality of client devices in the information technology infrastructure environment which have client-side execution agents installed therein for facilitating the offload of the execution of said at least a subset of the plurality of tasks in the execution queue data structure from the one or more servers in the information technology infrastructure environment.

15. A computer program product comprising a non-transitory processor-readable storage medium having stored therein program code of one or more software programs, wherein the program code when executed by at least one processing device causes the at least one processing device:
to maintain an execution queue data structure, the execution queue data structure comprising a plurality of tasks to be executed, each of the plurality of tasks comprising execution of server-side code for one or more application services hosted by one or more servers in an information technology infrastructure environment;
to determine at least one of hardware and software requirements for the plurality of tasks in the execution queue data structure;
to determine at least one of hardware and software resources available on a set of client devices in the information technology infrastructure environment; and
to offload execution of at least a subset of the plurality of tasks in the execution queue data structure from the one or more servers in the information technology infrastructure environment to at least one of the set of client devices in the information technology infrastructure environment based at least in part on mapping the determined available hardware and software resources of the set of client devices in the information technology infrastructure environment with the determined hardware and software requirements for the plurality of tasks in the execution queue data structure.

16. The computer program product of claim 15 wherein offloading execution of a given one of the plurality of tasks in the execution queue data structure from the one or more servers in the information technology infrastructure environment to at least a given one of the set of client devices in the information technology infrastructure environment is further based at least in part on results of execution of one or more historical tasks by the given client device in the information technology infrastructure environment.

17. The computer program product of claim 16 wherein the results of execution of the one or more historical tasks by the given client device in the information technology infrastructure environment characterize effectiveness of the given client device in executing the one or more historical tasks, the effectiveness being determined based at least in part on at least one of speed of execution of the one or more historical tasks and whether any errors were encountered during execution of the one or more historical tasks.

18. A method comprising:
maintaining an execution queue data structure, the execution queue data structure comprising a plurality of tasks to be executed, each of the plurality of tasks comprising execution of server-side code for one or more application services hosted by one or more servers in an information technology infrastructure environment;
determining at least one of hardware and software requirements for the plurality of tasks in the execution queue data structure;
determining at least one of hardware and software resources available on a set of client devices in the information technology infrastructure environment; and
offloading execution of at least a subset of the plurality of tasks in the execution queue data structure from the one or more servers in the information technology infrastructure environment to at least one of the set of client devices in the information technology infrastructure environment based at least in part on mapping the determined available hardware and software resources of the set of client devices in the information technology infrastructure environment with the determined hardware and software requirements for the plurality of tasks in the execution queue data structure;
wherein the method is performed by at least one processing device comprising a processor coupled to a memory.

19. The method of claim 18 wherein offloading execution of a given one of the plurality of tasks in the execution queue data structure from the one or more servers in the information technology infrastructure environment to at least a given one of the set of client devices in the information technology infrastructure environment is further based at least in part on results of execution of one or more historical tasks by the given client device in the information technology infrastructure environment.

20. The method of claim 19 wherein the results of execution of the one or more historical tasks by the given client device in the information technology infrastructure environment characterize effectiveness of the given client device in executing the one or more historical tasks, the effectiveness being determined based at least in part on at least one of speed of execution of the one or more historical tasks and whether any errors were encountered during execution of the one or more historical tasks.
